(19) United States
(12) Patent Application Publication
(10) Pub. No.: US 2010/0263014 A1
(43) Pub. Date: Oct. 14, 2010

(54) APPARATUS AND METHOD FOR PROCESSING BROADCASTING DATA IN IP BROADCASTING RECEIVER

(76) Inventor: Jae Ok Ha, Seoul (KR)

Correspondence Address: KED & ASSOCIATES, LLP, P.O. Box 221200, Chantilly, VA, 20153-1200, US

(21) Appl. No.: 12/740,767

(22) PCT Filed: Oct. 30, 2008
(86) PCT No.: PCT/KR08/06396

§ 371 Date: Apr. 30, 2010

(30) Foreign Application Priority Data
Nov. 1, 2007 (KR) 10-2007-0110995

(51) Int. Cl. H04N 7/173

(52) U.S. Cl. 725/131

(57) ABSTRACT

A method of processing broadcasting data in an IP broadcasting receiver such as an IP television (IP-TV) or an IP set-top box (IP-STB) for receiving various contents and Browser broadcasting streams through Internet is provided. A broadcasting data processing device in an IP broadcasting receiver includes: a packet filter for separating and outputting a bit stream of the specific channel with reference to IP header information of a selectively received bit stream among bit streams that are provided through Internet; an IP tuner for receiving a separatedly output bit stream of the specific channel; and an IP stack for separating and outputting the remaining bit streams except for a bit stream of the specific channel to the corresponding program.

### TECHNICAL FIELD

The present invention relates to an apparatus and method for processing broadcasting data in an Internet Protocol (IP) broadcasting receiver.

### BACKGROUND ART

An IP broadcasting receiver such as an IP set-top box (IP-STB) includes, for example, an Internet module for receiving a broadcasting stream through Internet, as shown in FIG. 1.

Further, an IP broadcasting receiver 20 is connected to a television 10 for outputting a video image and audio and is connected to an Internet server, for example, a contents provider server 40 for providing various types of contents and broadcasting programs through the Internet 30.

The contents provider server 40 and the IP-STB 20 process, transmit, and receive data according to, for example, a communication protocol of an open systems inter-connection (OSI) 7 layer, as shown in FIG. 2.

A first layer to a seventh layer of the OSI 7 layer are divided into a physical layer, a data link layer, a network layer, a transport layer, a session layer, a presentation layer, and an application layer.

Further, in each layer header information intrinsic to an corresponding layer is added to user data. The contents provider server 40 sequentially adds an application header AH, a presentation header PH, a session header SH, a transport header TH, a network header NH, and a data link header DLH to user data to transmit, and then converts the user data to a bit stream and transmits it, as shown in FIG. 2.

The IP-STB 20 for receiving the bit stream sequentially divides the data link header DLH, the network header NH, the transport header TH, the session header SH, the presentation header PH, and the application header AH, and then processes the user data.

For example, as shown in FIG. 3, a network device driver 200, an IP-stack 210, and sockets 200₁ to 200ₙ of each program are included in the IP-STB 20.

The network device driver 200 checks a media access control address (MAC address) from header information added to a data stream of various contents provided through Internet and selectively receives only a data stream corresponding to an intrinsic MAC address that is given to its own.

Further, the IP stack 210 analyzes the remaining various header information of a data stream selectively received by the network device driver 200, outputs each data packet to the corresponding program sockets (socket 1 to n), and allocates, for example, programs corresponding to a web browser to the first socket 200₁, a messenger to the second socket 200₂, and a VOD to an (n−1)th socket 200ₙ₋₁, and an IP-tuner to an n-th socket 200ₙ, as shown in FIG. 3.

For example, a two-way of transmission control protocol (TCP) packet and a one-way of user datagram protocol (UDP) packet may be output to the first socket 200₁ and the second socket 200₂, and a one-way of UDP packet may be output to the (n−1)th socket 200ₙ₋₁ and the n-th socket 200ₙ.

The UDP packet that is output to the n-th socket 200ₙ is a broadcasting stream of a specific channel selected by a user and is input to a digital signal processor (DSP) (not shown) via the IP-tuner, so a user can view a video image and audio sound of a broadcasting program that is provided from the contents provider server 40.

However, as described above, because the IP stack 210 analyzes various header information of a data stream received via the network device driver 200 and divides and outputs each data stream into the corresponding program socket, high performance of processing speed and processing capability are required for the IP stack 210, and when several programs are simultaneously operated, a problem that a load of the IP stack 210 increases occurs.

Further, because the IP stack is designed for a general-purpose to correspond to a communication protocol of an OSI 7 layer, the IP stack cannot be arbitrarily changed, as needed.

### DISCLOSURE OF INVENTION

### Technical Problem

The present invention has been made in view of the above problems, and provides an apparatus and method for directly outputting a data stream of a broadcasting channel selected by a user to an IP-tuner without via an IP stack within an IP broadcasting receiver such as an IP-STB.

### Technical Solution

In accordance with an aspect of the present invention, there is provided a method of processing broadcasting data in an IP broadcasting receiver, including: selecting a broadcasting stream of a specific channel among bit streams that are received through Internet; and outputting the selected broadcasting stream of the specific channel to an IP tuner and outputting the remaining bit streams to an IP stack.

In accordance with another aspect of the present invention, there is provided a broadcasting data processing device in an IP broadcasting receiver, including: a packet filter for separating and outputting a bit stream of a specific channel with reference to IP header information of a selectively received bit stream among bit streams that are provided through Internet; an IP tuner for receiving the separatedly output bit stream of the specific channel; and an IP stack for separating and outputting the remaining bit streams except for a bit stream of the specific channel to the corresponding program.

The packet filter may separate and output a broadcasting stream of a specific channel with reference to a destination address and a destination port value included within the IP header of the selectively received bit stream.

The IP tuner may designate a destination address and a destination port value for separating and outputting a broadcasting stream of a specific channel to the packet filter.

A broadcasting stream of a specific channel that is output to the IP tuner may be a multicasted UDP packet.

The packet filter may output a two-way of TCP packet and an UDP packet except for a broadcasting stream of the specific channel to the IP stack.

The broadcasting data processing device may further include a network device driver for selectively receiving a bit stream with reference to a MAC address among bit streams provided through Internet.

### Advantageous Effects

Therefore, an amount of a data stream that is to be input to the IP stack can be remarkably reduced, a system load of an IP broadcasting receiver can be prevented from abruptly increasing, and a design of an IP stack that is designed for a general-purpose may not be arbitrarily changed.

### BRIEF DESCRIPTION OF THE DRAWINGS

FIG. 1 is a diagram illustrating an exemplary embodiment of a general IP broadcasting receiver connected to a television and a contents provider server;

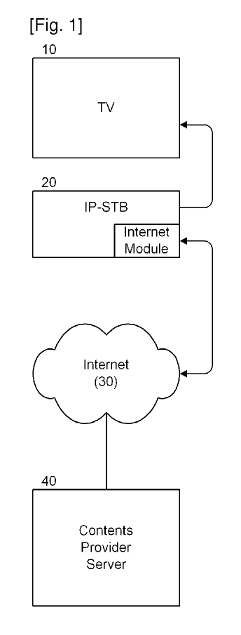

FIG. 2 is a diagram illustrating an exemplary embodiment of a general IP broadcasting receiver and a contents provider server for communicating through an OSI 7 layer;

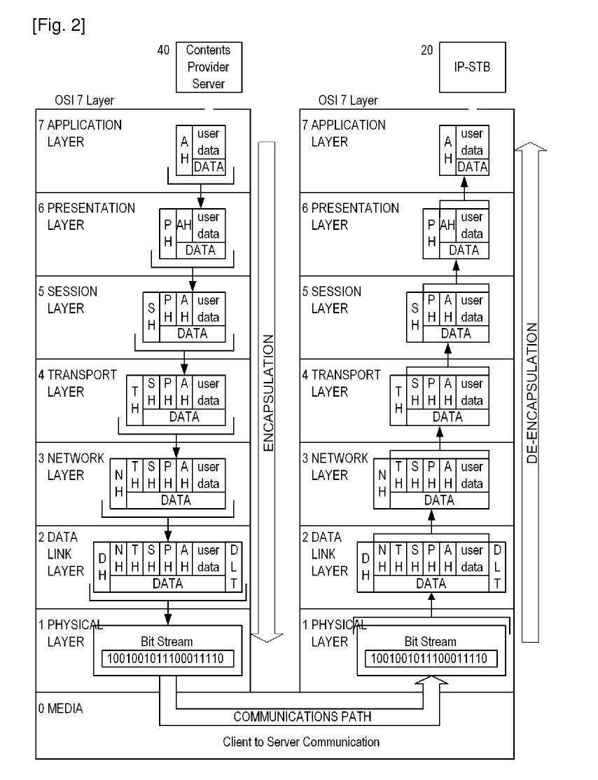

FIG. 3 is a block diagram illustrating a data processing process in a general IP broadcasting receiver;

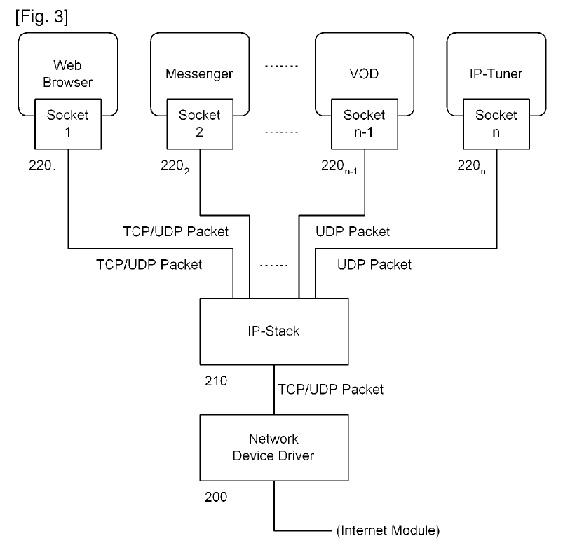

FIG. 4 is a diagram illustrating a configuration of an IP broadcasting receiver to which the present invention is applied;

FIG. 5 is a block diagram illustrating a broadcasting data processing process in an IP broadcasting receiver to which the present invention is applied; and

FIG. 6 is a flowchart illustrating a broadcasting data processing process in an IP broadcasting receiver to which the present invention is applied.

### BEST MODE FOR CARRYING OUT THE INVENTION

An apparatus and method for processing broadcasting data in an IP broadcasting receiver according to an exemplary embodiment of the present invention are described hereinafter in detail with reference to the accompanying drawings.

First, the apparatus and method for processing broadcasting data according to an exemplary embodiment of the present invention may be applied to various types of IP broadcasting receivers such as an IP-television (IP-TV) or an IP-STB.

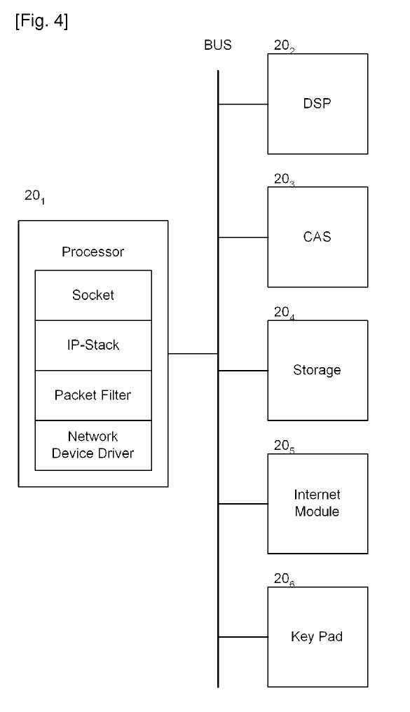

As shown in FIG. 4, for example, a processor 20₁, a digital signal processor 20₂, a conditional access system 20₃, a storage 20₄, an Internet module 20₅, and a keypad 20₆ are connected through a bus line to an IP-STB 20 to which the present invention is applied.

Further, the processor 20₁ includes a network device driver, an IP-stack, and sockets of each program and for example, further includes a packet filter between the network device driver and the IP stack, as shown in FIG. 4.

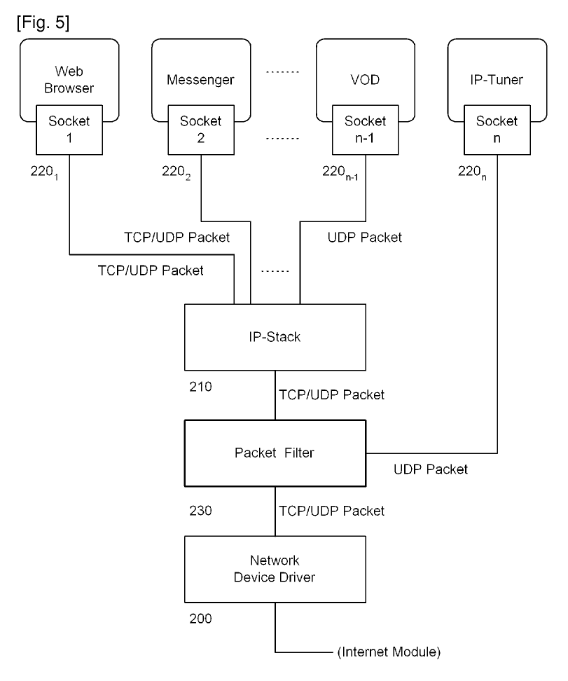

As shown in FIG. 5, the network driver 200 checks a MAC address from header information that is added to a data stream that is received through the Internet module 20 ₅, and when the MAC address corresponds to an intrinsic MAC address that is given to its own, the network driver 200 selectively receives only a data stream corresponding thereto.

A packet filter 230 selectively separates only a data stream in which a specific IP address is included in header information among data streams selectively received by the network device driver 200 and outputs the data stream to the IP-tuner socket 200ₙ.

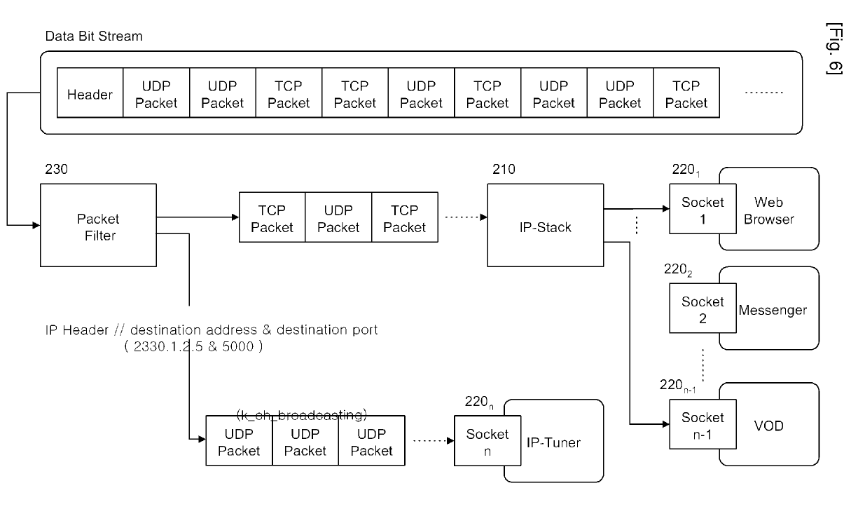

As shown in FIG. 6, if the user selects, for example, a broadcasting channel (e.g. CH 11), the IP-tuner notifies and designates a destination address (e.g. destination address =2330.1.2.5) and a destination port (e.g. destination port =5000) value of an IP header corresponding to the selected channel to the packet filter 230.

The packet filter 230 selects only a data stream in which the destination address (e.g. 2330.1.2.5) and the destination port (e.g. 5000) value are recorded within the IP header among data streams that are received via the network device driver 200 with reference to the designated destination address (e.g. 233.1.2.5) and destination port (e.g. 5000) value and directly outputs the data stream to the IP-tuner socket 220ₙ.

Accordingly, a data stream that is separated and output by the packet filter, i.e. a data stream of a specific broadcasting channel that is selected by the user is input to the IP tuner socket 220n, and a data stream of the specific broadcasting channel passes through the IP tuner and the digital signal processing 202, and is output as a video image and audio sound and thus the user can view a broadcasting program of a specific channel selected by his own.

Further, the packet filter 230 outputs the remaining data streams, except for a data stream in which the destination address and the destination port value are recorded, to the IP stack 210, and the IP stack 210 analyzes all header information of the data stream input as described above and separates and outputs each data stream to each of the program sockets such as a web browser, a messenger, and a VOD.

The IP stack 210 outputs, for example, a two-way of TCP packet and a one-way of UDP packet to a web browser socket and a messenger socket and outputs a one-way of UDP packet to a VOD socket.

Because the packet filter 230 separates an UDP packet corresponding to a data stream of the specific broadcasting channel and directly outputs the UDP packet to the IP tuner socket, an amount of data streams that are input to the IP stack 210 greatly decreases.

Further, because the IP stack analyzes only header information of a data stream that is input as described above, i.e. the remaining data streams, except for a data stream of a specific broadcasting channel, a system load does not greatly increase and a design of an IP stack designed for a general-purpose may not be arbitrarily changed.

For reference, the packet filter may be changed and replaced to a random different term. An exemplary embodiment of the present invention is described for a purpose of illustration and it will be understood by those skilled in the art that various changes in form and details may be made therein without departing from the spirit and scope of the invention as defined by the appended claims.

1. A method of processing broadcasting data in an IP broadcasting receiver, comprising:
selecting a broadcasting stream of a specific channel among bit streams that are received through Internet; and
outputting the selected broadcasting stream of the specific channel to an IP tuner and outputting remaining bit streams to an IP stack.

2. The method of claim 1, wherein the broadcasting stream of the specific channel is selected based on a destination address and a destination port value included within an IP header of the bit stream that is received through Internet.

3. The method of claim 2, wherein the destination address and the destination port value for selecting a broadcasting stream of the specific channel are designated by the IP tuner.

4. The method of claim 1, wherein the broadcasting stream of a specific channel that is output to the IP tuner is a multicasted user datagram protocol (UDP) packet.

5. The method of claim 1, wherein the bit stream that is output to the IP stack includes two-way transmission control protocol (TCP) packets and UDP packets except for the broadcasting stream of the specific channel.

6. A broadcasting data processing device in an IP broadcasting receiver, comprising:
a packet filter for separating and outputting a bit stream of a specific channel with reference to IP header information of a selectively received bit stream among bit streams that are provided through Internet;
an IP tuner for receiving the separatedly output bit stream of the specific channel; and
an IP stack for separating and outputting remaining bit streams except for a bit stream of the specific channel to the corresponding program.

7. The broadcasting data processing device of claim 6, wherein the packet filter separates and outputs a broadcasting stream of a specific channel with reference to a destination address and a destination port value included within the IP header of the selectively received bit stream.

8. The broadcasting data processing device of claim 6, wherein the IP tuner designates a destination address and a destination port value for separating and outputting a broadcasting stream of a specific channel to the packet filter.

9. The broadcasting data processing device of claim 6, wherein a broadcasting stream of a specific channel that is output to the IP tuner is a multicasted UDP packet.

10. The broadcasting data processing device of claim 6, wherein the packet filter outputs a two-way of TCP packet and an UDP packet except for a broadcasting stream of the specific channel to the IP stack.

11. The broadcasting data processing device of claim 6, further comprising a network device driver for selectively receiving a bit stream with reference to a MAC address among bit streams provided through Internet.
